(19) United States
(12) Patent Application Publication
(10) Pub. No.: US 2013/0008730 A1
(43) Pub. Date: Jan. 10, 2013

(54) FUEL-CELL-POWERED VEHICLE

(75) Inventors: Hiroki Yahashi, Toyota-shi (JP); Tsukuo Ishitoya, Toyota-shi (JP)

(73) Assignee: TOYOTA JIDOSHA KABUSHIKI KAISHA, Toyota-shi, Aichi-ken (JP)

(21) Appl. No.: 13/635,447

(22) PCT Filed: Mar. 1, 2011
(86) PCT No.: PCT/IB2011/000419

§ 371 Date: Sep. 17, 2012

(30) Foreign Application Priority Data
Mar. 18, 2010 (JP) 2010-061865

(51) Int. Cl. B60L 11/18

(52) U.S. Cl. 180/65.31

(57) ABSTRACT

A fuel-cell-powered vehicle (10) includes a cover (28) that covers and protects a tank (18) mounted on a lower portion of the vehicle body. An introduction port (32) is formed in the cover (28) in front of the tank (18) of the vehicle to introduce air into the space within the cover (28). In addition, a discharge port (34) is formed in the cover (28) behind the tank (18) of the vehicle to discharge the air introduced into the space within the cover (28) from the introduction port (32).

### BACKGROUND OF THE INVENTION

1. Field of the Invention

The invention relates to a fuel-cell-powered vehicle. In particular, the invention relates to an improvement in a mounting structure of a tank that is used to store fuel gas for a fuel cell.

2. Description of the Related Art

Generally, fuel-cell-powered vehicles are powered using by electric power generated by a fuel cell to which a fuel such as hydrogen gas or the like is supplied. In such fuel-cell-powered vehicles, the fuel gas for the fuel cell is typically stored in a tank under high-pressure, and the tank may be mounted on a lower portion of the vehicle body to ensure the largest possible vehicle compartment space. Generally, the tank is covered with a cover and protected against external environments such as road surfaces, steppingstones, water and the like.

The fuel gas stored in the tank is supplied to the fuel cell. When the pressure in the tank falls, the temperature of the tank usually decreases. If the temperature of the tank drastically falls, the tank may become damaged due to the contraction of the tank itself.

Japanese Patent Application Publication No. 2009-78623 (JP-A-2009-78623) describes a fuel-cell-powered two-wheeled vehicle, a cooling fan used to cool the fuel cell, and a fuel cylinder used to store the fuel gas supplied to the fuel cell. In the vehicle described in JP-A-2009-78623, the cooling fan blows air, which has been warmed after cooling the fuel cell, toward the fuel cylinder, thereby preventing the temperature of the fuel steel cylinder from falling as the fuel gas is consumed.

Japanese Patent Application Publication No. 2006-188170 (JP-A-2006-188170) describes a vehicle that includes a gaseous fuel tank installed on a roof of a vehicle body, and a roof cover that covers and protects the gaseous fuel tank. Further, it JP-A-2006-188170 also describes the formation of an outside air introduction portion through the roof cover, and that wind blowing against the vehicle during the traveling thereof is introduced into the roof cover through the outside air introduction portion.

In a conventional fuel-cell-powered vehicle, when the temperature of a tank falls to a certain value (e.g., −40° C.), the pressure in the tank is restrained from falling. In other words, by reducing the flow rate of the fuel gas supplied to a fuel cell, further decreases in the temperature of the tank are avoided. With this method, however, the output of the fuel cell falls due to the reduction in the flow rate of the fuel gas, and as a result, the traveling performance of the vehicle deteriorates.

As described in JP-A-2009-78623, the fan may be provided for circulate air and to suppress decreases in the temperature of the tank when operated. However, as described above, in the fuel-cell-powered vehicle with the tank mounted on the lower portion of the vehicle body, the fan and the cover for protecting the fan need to be provided on the lower portion of the vehicle body. As a result, the structure of the fuel-cell-powered vehicle becomes complicated.

### SUMMARY OF THE INVENTION

The invention provides a fuel-cell-powered vehicle that is simple in structure and that effectively restrains decreases in the temperature of a tank mounted on a lower portion of a vehicle body.

A fuel-cell-powered vehicle according to an aspect of the invention is a fuel-cell-powered vehicle having a fuel cell, a tank, mounted on a lower portion of a vehicle body, in which a fuel gas that is supplied to the fuel cell is stored under high pressure, and a cover that covers and protects the tank. In this fuel-cell-powered vehicle, the cover has an introduction port, through which air is introduced into a space within the cover, and a discharge port, through which air introduced into the space within the cover from the introduction port is discharged, are formed in the cover, with the introduction port formed in front of the tank of the vehicle and the discharge port is formed behind the tank of the vehicle.

Further, the fuel-cell-powered vehicle according to the foregoing aspect of the invention may include an exhaust gas passage that connects the fuel cell with the introduction port and through which exhaust gas discharged from the fuel cell flows.

Further, the fuel-cell-powered vehicle according to the foregoing aspect of the invention may include a plurality of tanks identical to the tank. The plurality of the tanks may be mounted on the vehicle body sequentially from before backward of the vehicle, and a duct that channels some of the air introduced through the introduction port backward from that one of the plurality of the tanks which is located in front of any of the other tanks with respect to the vehicle may be formed in the cover.

Further, in the fuel-cell-powered vehicle according to the foregoing aspect of the invention, a guide portion that guides air flowing out from an outlet of the duct into that one of the tanks which is located behind the outlet of the duct may be formed in the cover

Further, the fuel-cell-powered vehicle according to the foregoing aspect of the invention may include a plurality of tanks identical to the tank in front of each of which an additional tank is disposed of the vehicle, and a plurality of ducts identical to the duct and a plurality of guide portions identical to the guide portion that are provided to guide the air introduced from the introduction port into the respective tanks in front of each of which the additional tank is disposed.

Further, in the fuel-cell-powered vehicle according to the foregoing aspect of the invention, the discharge port may be formed through at least one of a lower face of the cover and a rear face of the cover.

Further, in the fuel-cell-powered vehicle according to the foregoing aspect of the invention, the introduction port and the discharge port may be identical in shape.

The fuel-cell-powered vehicle according to the invention may effectively restrain the temperature of the tank mounted on the lower portion of the vehicle body from falling with a simple structure.

### BRIEF DESCRIPTION OF THE DRAWINGS

The foregoing and/or further objects, features and advantages of the invention will become more apparent from the following description of example embodiments of the invention with reference to the accompanying drawings, in which like numerals are used to represent like elements and wherein:

FIG. 1 is a view showing a construction of a fuel cell system mounted on a fuel-cell-powered vehicle according to the first embodiment of the invention;

FIG. 2 is a view showing an overall construction of the lower portion of the vehicle body on which a tank according to the first embodiment of the invention is mounted, as viewed from a location beside the vehicle;

FIG. 3 is a plan view of the interior of a cover according to the first embodiment of the invention, as viewed from above; and

FIG. 4 is a view showing an overall construction of the lower portion of the vehicle body on which a tank according to the second embodiment of the invention is mounted, as viewed from a location beside the vehicle.

### DETAILED DESCRIPTION OF EMBODIMENTS

Embodiments of a fuel-cell-powered vehicle according to the invention will be described hereinafter using the drawings.

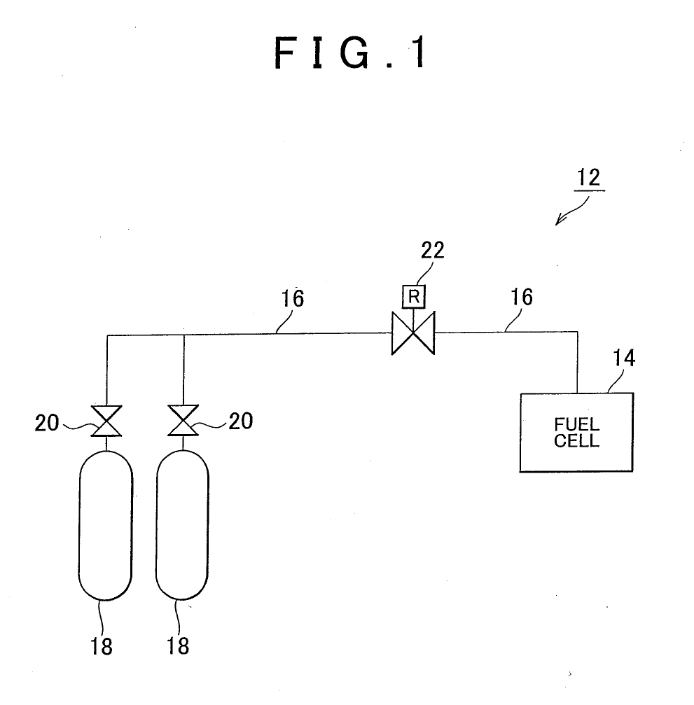

First, a fuel cell system 12 mounted on a fuel-cell-powered vehicle 10 according to the first embodiment of the invention will be described with reference to FIG. 1. The fuel cell system 12 includes a fuel cell 14 that generates electricity through an electrochemical reaction between a fuel gas and an oxidation gas. It should be noted that the fuel gas used for the fuel cell system 12 is hydrogen, and that the oxidation gas is air.

A fuel gas flow channel 16 through which the fuel gas is supplied to an anode (not shown) of the fuel cell 14 and an oxidation gas flow channel (not shown) through which the oxidation gas is supplied to a cathode (not shown) of the fuel cell 14 are connected to the fuel cell 14.

The fuel cell 14 is a proton-exchange membrane fuel cell that employs an electrolyte membrane as a proton-conductive membrane body formed of a high-polymer material such as a fluorocarbon resin or the like. Each unit cell (not shown) of the cell is constructed by further sandwiching a membrane electrode assembly (an MEA), which is constructed by sandwiching the electrolyte membrane between an anode and a cathode, between two separators. The fuel cell 14 is constructed by laminating a plurality of such unit cells on one another.

The fuel cell system 12 includes two tanks 18 that serve as fuel gas sources for supplying the fuel gas to the fuel cell 14. The fuel gas is stored in the tanks 18 under high-pressure (e.g., 70 MPa). The fuel gas flow channel 16 connects the tanks 18 to the fuel cell 14. It should be noted that the number of the tanks 18 described in the embodiment is merely an example, and that the number of the tanks 18 according to the invention is not absolutely required to be two as will be described later.

The fuel gas flow channel 16 is fitted with main check valves 20 and a pressure reducing valve 22, in the stated order, in the direction from the tanks 18 toward the fuel cell 14. The main check valves 20 are so fitted to the fuel gas flow channel 16 as to correspond to the tanks 18 respectively. The main check valves 20 are electromagnetic valves that are actuated by driving an electromagnet through an electric signal. The pressure reducing valve 22 reduces the pressure (e.g., 70 MPa) of the fuel gas introduced from the tanks 18 to a pressure (e.g., 1 MPa) suited for the fuel cell 14 to which the fuel gas is supplied.

By driving a motor (not shown) that serves as a prime mover using the electric power output from the fuel cell system 12 thus constructed, the fuel-cell-powered vehicle 10 is able to move.

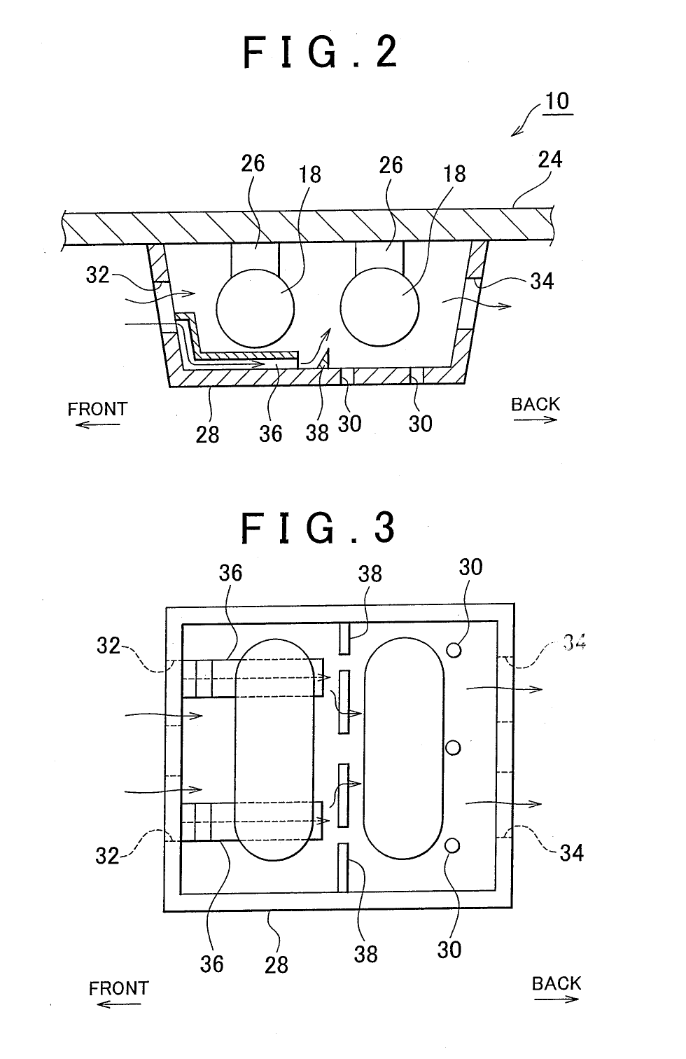

Next, the construction of the fuel-cell-powered vehicle 10 according to this embodiment of the invention will be described with reference to FIGS. 2 and 3. FIG. 2 is a view showing an overall construction of the lower portion of the vehicle body on which the tanks are mounted, as viewed from a location beside the vehicle. FIG. 3 is a plan view of the interior of the cover as viewed from above.

In the fuel-cell-powered vehicle 10 according to this embodiment of the invention, the two tanks 18 are disposed on a lower portion of a body frame 24 as a lower structure of the vehicle body. The tanks 18 are fixed to the body frame 24 via fixing brackets 26.

These tanks 18 are formed cylindrically, that is, in the shape of a so-called cylinder so as to disperse the pressure of a fuel gas stored in the tanks 18. The two tanks 18 are disposed sequentially from before backward of the vehicle and in such a manner as to extend in a vehicle width direction respectively.

Further, the body frame 24 includes a cover 28 for covering the tanks 18. The cover 28 is a so-called undercover that covers the tanks 18 to protect the tanks 18 against external environments such as road surfaces, steppingstones, water and the like and prevent the tanks 18 from being damaged or deteriorated. Debris spill holes 30 to allow stones, water and other debris that may have entered a space inside the cover 28 to fall are formed through the lower face of the cover 28.

In the fuel-cell-powered vehicle 10 according to this embodiment of the invention, the cover 28 is characterized by having introduction ports 32 for introducing air into the space inside the cover 28, and discharge ports 34 for discharging the air introduced into the space inside the cover 28 from the introduction ports 32. The introduction ports 32 are formed in front of the tanks 18 with respect to the vehicle, and the discharge ports 34 are formed behind the tanks 18 with respect to the vehicle.

In the fuel-cell-powered vehicle 10, outside air is supplied to the tanks 18 when the vehicle is in motion using a simple structure. That is, while the vehicle is moving, the headwind introduces air into the space inside the cover 28 through the introduction ports 32, and the introduced air effectively exchanges heat with the tanks 18 and is then discharged through the discharge ports 34. It should be noted herein that the tank 18 may be warmed through the heat exchange between the tanks 18 and the introduced air when the temperatures of the tanks 18 are below the temperature of the introduced air. Accordingly, even if the temperatures of the tanks 18 have drastically fallen due to the consumption of the fuel gas, the decrease in the temperature of the tanks 18 may be suppressed by the air introduced into the space inside the cover 28 while the vehicle is moving, without suppressing the output of the fuel cell.

The two introduction ports 32 are formed in a front face of the cover 28, and the two discharge ports 34 are formed in a rear face of the cover 28 opposed to the front face thereof. To reduce the cost of manufacturing, the introduction ports 32 and the discharge ports 34 may be identically shaped. It should be noted that the number of introduction ports 32 and the number of discharge ports 34 described herein are merely examples and the invention may be implemented using any number of ports that may be suitable for the particular application. Further, although the discharge ports 34 in this embodiment of the invention are shown formed in the rear face of the cover 28, the invention is not limited to this configuration. As long as the air that has been introduced inside the cover 28 and that has exchanged heat with the tanks 18 may be smoothly discharged, the discharge ports 34 may be formed through a lower face of the cover 28.

Further, in the fuel-cell-powered vehicle 10 according to this embodiment of the invention, the two tanks 18 are mounted sequentially from before backward with respect to the vehicle. In this configuration, the air cooled through the heat exchange with the tank 18 located in front directly flows toward the tank 18 located behind. Therefore, the efficiency of heat exchange for the tank 18 located behind drops. Then, the temperatures of the two tanks 18 cannot be homogeneously restrained from falling.

Thus, as shown in FIGS. 2 and 3, ducts 36 for introducing the air introduced through the introduction ports 32 backward from the tank 18 located in front are provided inside the cover 28. With these ducts 36, the tank 18 located behind may be supplied with the air at the same temperature as the air supplied to the tank 18 located in front of that tank 18. Thus, the temperatures of the two tanks 18 are restrained from falling as homogeneously as possible.

The ducts 36 are connected to parts of regions of the introduction ports 32 to supply part of the air introduced from the introduction ports 32 backward. The ducts 36 are so formed as to extend past a space below the front tank 18. However, the invention is not restricted to this configuration. As long as air is introduced rearward from the tank 18 located in front, the ducts 36 may be so formed as to extend through another route, for example, past a space above the front tank 18.

Further, guide portions 38 for guiding the air flowing out from outlets of the ducts 36 to the rear tank 18 from the outlets are provided inside the cover 28. The air guided by these guide portions 38 can effectively come into contact with the tank 18 located behind. Therefore, the area of contact between the air and the tank 18 located behind increases. By increasing the contact area with the air flowing inside the cover 28, the efficiency of heat exchange for the rear tank 18 is enhanced. Therefore, the suppression of falls in the temperatures of the tanks 18 inside the cover 28 can further be homogenized.

As shown in FIG. 2, the guide portions 38 have inclined faces that protrude from the cover 28 in an inclined manner, and air that hits these inclined faces is guided by the target tank 18. Further, as shown in FIG. 3, the plurality of guide portions 38 extend in the vehicle width direction. It should be noted that the number of the guide portions 38 is an example, and that the number of guide portions 38 may be adjusted to suit the particular application of the invention.

The fuel-cell-powered vehicle 10 according to the first embodiment of the invention facilitates heat exchange between the tanks 18 and outside air with a simple structure as described above, and hence can effectively restrain the temperatures of the tanks 18 from falling.

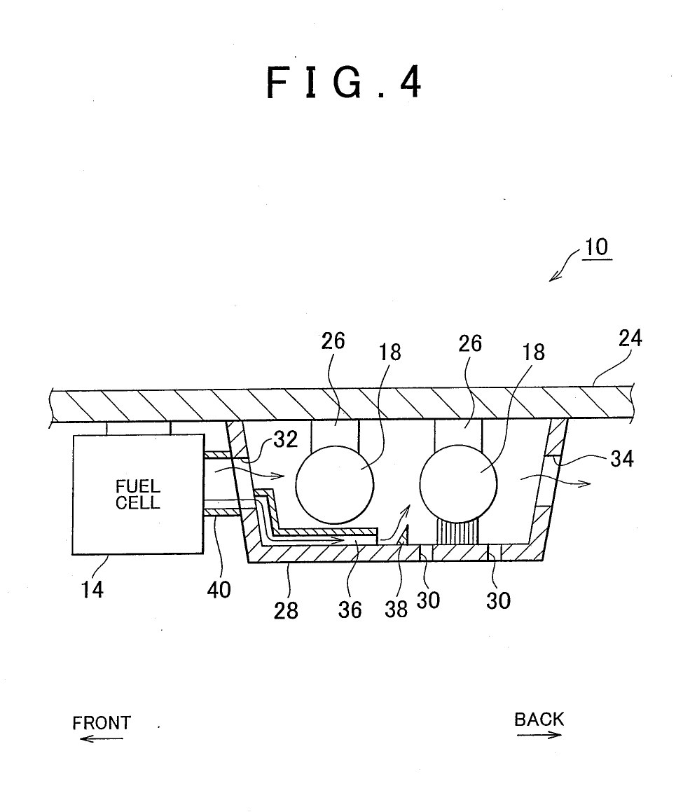

Next, the fuel-cell-powered vehicle 10 according to the second embodiment of the invention will be described with reference to FIG. 4. FIG. 4 is a view showing an overall construction of a lower portion of a vehicle body on which a tank according to the second embodiment of the invention is mounted, as viewed from a location beside the vehicle. It should be noted that components identical to those of the first embodiment of the invention are denoted using the same reference symbols, and that a detailed description of those components will be omitted.

In the fuel-cell-powered vehicle 10 according to the second embodiment of the invention, the fuel cell 14 is disposed in front of the cover 28 on a lower portion of the body frame 24. The fuel-cell-powered vehicle 10 has an exhaust gas passage 40 that connects the fuel cell 14 to the introduction ports 32 and through which the exhaust gas discharged from the fuel cell 14 flows. With the exhaust gas passage 40, high-temperature (e.g., 80° C.) exhaust gas is introduced into the space within the cover 28 from the operative fuel cell 14. Thus, because the temperature of exhaust gas is higher than the temperature of outside air, the temperatures of the tanks 18 can be more effectively restrained from falling than in the structure of the fuel-cell-powered vehicle 10 according to the first embodiment of the invention.

In the second embodiment of the invention, the fuel cell 14 is described as being disposed on the lower portion of the body frame 24. However, the invention is not restricted to this construction. As long as exhaust gas of the fuel cell 14 may be sent through the exhaust gas passage 40 to the cover 28, the fuel cell 14 may also be provided on an upper portion of the body frame 24.

In the second embodiment of the invention, the introduction ports 32 are connected to the exhaust gas passage 40. However, the invention is not restricted to this construction. To ensure that the predetermined amount of air is introduced into the space inside the cover 28, some of the introduction ports 32 may be connected to the exhaust gas passage 40, and the rest of the introduction ports 32 may be opened to the outside.

In the two embodiments of the invention described above include two tanks 18. However, the invention is not restricted to the use of two tanks 18. If only one tank 18 is used, the ducts 36 and the guide portions 38 may be omitted. Further, if three or more tanks 18 are used, the duct portions 36 corresponding to the plurality of the rear tanks 18 respectively and the guide portions 38 corresponding to the plurality of the rear tanks 18 respectively may be provided to enhance the efficiency of heat exchange for the plurality of the rear tanks 18.

The invention has been described with reference to the example embodiments of the invention for illustrative purposes only. It should be understood that the description is not intended to be exhaustive or to limit the form of the invention and that the invention may be adapted for use in other systems and applications. The scope of the invention embraces various modifications and equivalent arrangements that may be conceived by those skilled in the art.

1. A fuel-cell-powered vehicle comprising:
a fuel cell;
a plurality of tanks, mounted on a lower portion of a vehicle body, in which a fuel gas that is supplied to the fuel cell is stored under high pressure; and
a cover that covers and protects the tank, wherein:
an introduction port, through which air is introduced into a space within the cover, and a discharge port, through which air introduced into the space within the cover from the introduction port is discharged, are formed in the cover, with the introduction port formed in front of the tank of the vehicle and the discharge port formed behind the tank of the vehicle;
the plurality of the tanks are mounted on the vehicle body sequentially from before backward of the vehicle; and
a duct that channels some of the air introduced through the introduction port backward from that one of the plurality of the tanks which is located in front of any of the other tanks with respect to the vehicle is formed in the cover.

2. The fuel-cell-powered vehicle according to claim 1, further comprising an exhaust gas passage that connects the fuel cell with the introduction port and through which exhaust gas discharged from the fuel cell flows.

3. (canceled)

4. The fuel-cell-powered vehicle according to claim 1, wherein a guide portion that guides air flowing out from an outlet of the duct into that one of the tanks which is located behind the outlet of the duct is formed in the cover.

5. The fuel-cell-powered vehicle according to claim 4, comprising a plurality of ducts identical to the duct and a plurality of guide portions identical to the guide portion, the plurality of ducts and the plurality of guide portions being provided to guide the air introduced from the introduction port into the respective tanks in front of each of which an additional tank is disposed.

6. The fuel-cell-powered vehicle according to claim 1, wherein the discharge port is formed through at least one of a lower face of the cover and a rear face of the cover.

7. The fuel-cell-powered vehicle according to claim 1, wherein the introduction port and the discharge port are identical in shape.
